(19) United States
(12) Patent Application Publication
(10) Pub. No.: US 2010/0321718 A1
(43) Pub. Date: Dec. 23, 2010

(54) IMAGE FORMING APPARATUS, METHOD FOR CONTROLLING THE SAME, AND RECORDING MEDIUM

(75) Inventor: Yoshiro Mihira, Inagi-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/817,037

(22) Filed: Jun. 16, 2010

(30) Foreign Application Priority Data
Jun. 22, 2009 (JP) 2009-148011

(51) Int. Cl. G06F 3/12; G06F 15/00

(52) U.S. Cl. 358/1.14; 358/1.15

(57) ABSTRACT

An image forming apparatus communicates with an information apparatus through wireless communication. The image forming apparatus determines whether data received from the information apparatus is in an e-mail format. When it is determined that the received data is in an e-mail format, the image forming apparatus displays a letting screen for letting a user select forming an image of the e-mail text or forming an image of an attached file. When it is determined that the received data is not an e-mail format, the apparatus displays a setting screen for setting an image forming condition, upon reception of the data.

### BACKGROUND OF THE INVENTION

1. Field of the Invention

The present invention relates to an image forming apparatus communicable with a portable information apparatus, a method for controlling the image forming apparatus, and a recording medium storing a program therefor.

2. Description of the Related Art

There is a technique for controlling a process for transmitting data kept by a portable information apparatus, such as a cellular phone, to an image forming apparatus, such as a printer.

For example, Japanese Patent Application Laid-Open No. 2007-79639 discusses a technique in which a user operates a cellular phone to select a print target file from files kept in the cellular phone, transmits and prints the selected file to and on the printer. In Japanese Patent Application Laid-Open No. 2007-79639, after the user selects the file to be printed, on the cellular phone, a screen for setting a printing condition(s) is displayed. Then, the user selects the printing condition on this screen.

The data kept by the portable information apparatus includes various kinds of data such as image data (photos), text data (memos), and e-mail data received by the portable information apparatus. The e-mail data may or may not include attached files.

Various kinds of data may be transmitted from the portable information apparatus to the image forming apparatus. It is convenient if the image forming apparatus receiving data from the portable information apparatus displays an operation screen suitable for the kind of corresponding data, according to the kind of received data. For example, when e-mail data is received, the user can select whether to process the e-mail text or attached file.

In the above conventional technique, no consideration was given to the operation screen of the image forming apparatus according to the kind of data to be transmitted, because the user operates only the cellular phone. For example, when e-mail data is printed on the image forming apparatus, the user cannot select whether to print the e-mail text or attached file by operating the image forming apparatus.

### SUMMARY OF THE INVENTION

According to an aspect of the present invention, an image forming apparatus communicable with an information apparatus through wireless communication, includes a determination unit configured to determine whether data received from the information apparatus is in an e-mail format, and a display unit configured, in response to reception of the data, to display a letting screen to let a user select forming an image of e-mail text included in the data or forming an image of an attached file included in the data, when the data is in an e-mail format, and to display a setting screen for setting an image forming condition, when the data is not in an e-mail format.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a diagram illustrating a system configuration of a system according to the present invention.

FIG. 2 is a diagram illustrating a hardware configuration of an image forming apparatus of the present exemplary embodiment.

FIG. 3 is a diagram illustrating a software configuration of an image forming apparatus of the present exemplary embodiment.

FIG. 4 is a diagram illustrating a recording table for function restriction information by each user.

FIG. 5 is a diagram illustrating a table for recording the active status of a license for each function.

FIG. 6 is a flowchart illustrating a process executed by the image forming apparatus of the present exemplary embodiment.

FIG. 7 is a flowchart illustrating a receiving process executed by the image forming apparatus of the present exemplary embodiment.

FIG. 8 is a flowchart illustrating a data analyzing process executed by the image forming apparatus of the present exemplary embodiment.

FIG. 9 is a flowchart illustrating a print process executed by the image forming apparatus of the present exemplary embodiment.

FIG. 10 illustrates an example of a screen displayed on a display unit of the image forming apparatus of the present exemplary embodiment.

FIG. 11 illustrates an example of a screen displayed on the display unit of the image forming apparatus of the present exemplary embodiment.

FIG. 12 illustrates an example of a screen displayed on the display unit of the image forming apparatus of the present exemplary embodiment.

FIG. 13 illustrates an example of a screen displayed on the display unit of the image forming apparatus of the present exemplary embodiment.

FIG. 14 illustrates an example of a screen displayed on the display unit of the image forming apparatus of the present exemplary embodiment.

FIG. 15 illustrates an example of a screen displayed on the display unit of the image forming apparatus of the present exemplary embodiment.

FIG. 16 illustrates an example of a screen displayed on the display unit of the image forming apparatus of the present exemplary embodiment.

FIG. 17 illustrates an example of a screen displayed on the display unit of the image forming apparatus of the present exemplary embodiment.

FIG. 18 illustrates an example of a screen displayed on the display unit of the image forming apparatus of the present exemplary embodiment.

FIGS. 19A and 19B illustrate examples of screens displayed on the display unit of the image forming apparatus of the present exemplary embodiment.

FIGS. 20A, 20B and 20C illustrate examples of screens displayed on the display unit of the image forming apparatus of the present exemplary embodiment.

### DESCRIPTION OF THE EMBODIMENTS

Various exemplary embodiments, features, and aspects of the invention will be described in detail below with reference to the drawings.

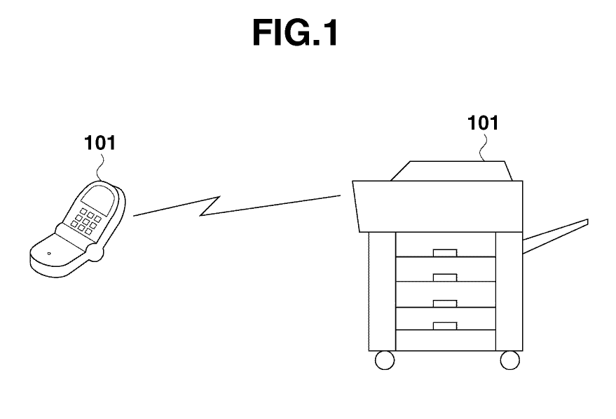

FIG. 1 is a diagram illustrating a system configuration of an exemplary embodiment according to the present invention. An image forming apparatus 101 can communicate with a cellular phone 102 through infrared communication. The image forming apparatus 101 includes a mobile print application function for printing data received from the cellular phone 102. The cellular phone 102 includes a function for transmitting data to the image forming apparatus 101 through infrared communication. The cellular phone 102 keeps various kinds of data, such as image data (photos), text data (memos), or received e-mail data. The cellular phone 102 can transmit those data to the image forming apparatus through infrared communication.

The image forming apparatus 101 can execute an image forming process for data received from a portable information apparatus, and may be a printer, a scanner, a FAX, or a multi-function machine. The portable information apparatus is not limited to a cellular phone, and may be any other unit, such as a personal digital assistant (PDA). The communication method for communication between the portable information apparatus and the image forming apparatus is not limited to infrared communication, such as infrared data application (IrDA), and may be Bluetooth, a wireless universal serial bus (USB), and a wireless local area network (LAN).

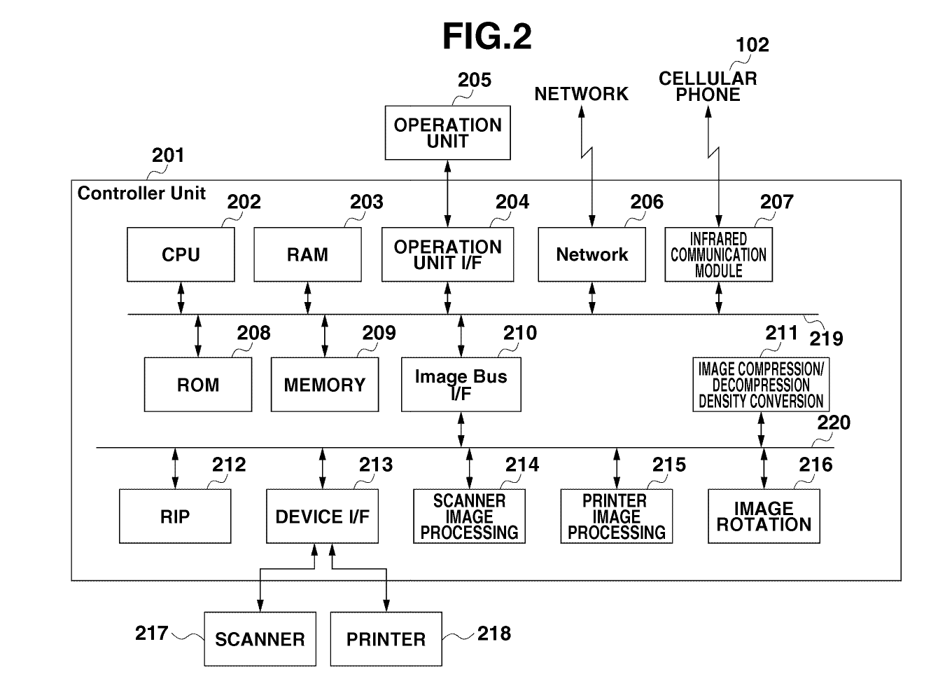

FIG. 2 is a block diagram illustrating a hardware configuration of the image forming apparatus 101 illustrated in FIG. 1.

In FIG. 2, a controller unit 201 is connected to a scanner 217 or printer 218. The scanner is an image input device which reads a document image, such as a document and inputs image data, while the printer 218 is an image output device.

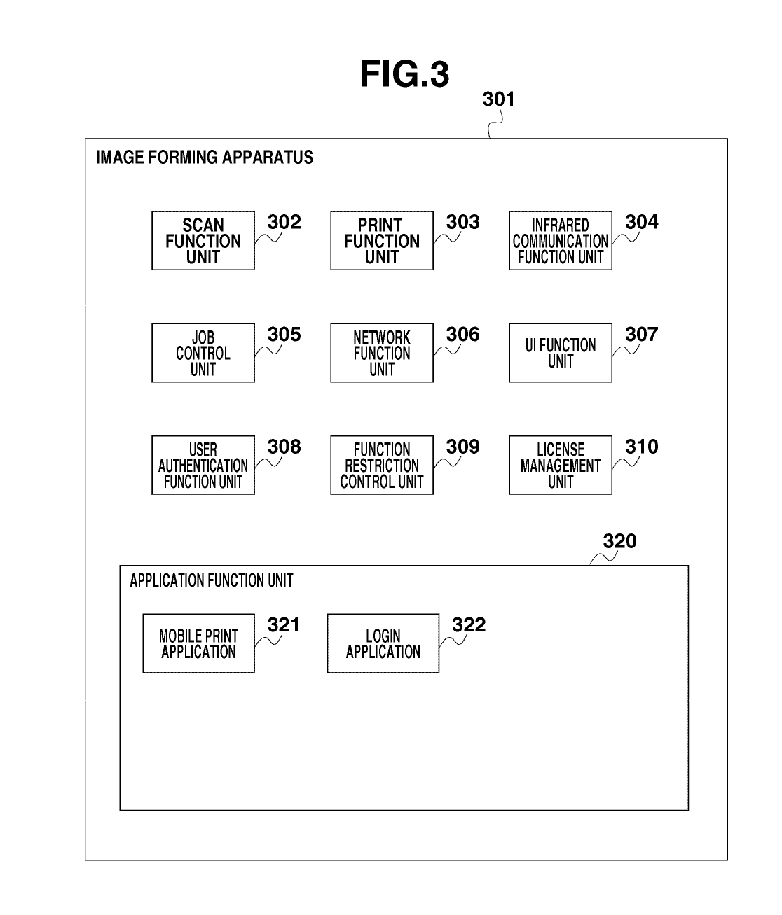

A central processing unit (CPU) 202 is a controller which controls the entire system in the image forming apparatus 101 illustrated in FIG. 1. A random access memory (RAM) 203 is a system work memory which keeps programs that are read and executed by the CPU 202, and is an image memory for temporarily storing target image data to be processed. A read-only memory (ROM) 208 is a boot ROM, and stores a boot program for the system of the image forming apparatus 101. A memory 209 is a hard disk drive of the image forming apparatus 101. The memory 209 stores system software (system program), application software (application program), and image data, illustrated in FIG. 3.

An operation unit interface (I/F) 204 is an interface unit for an operation unit 205, and outputs display data to be displayed on a display unit (not illustrated) provided in the operation unit 205, to the operation unit 205. The operation unit I/F 204 has a function for notifying the CPU 202 of information, which is input by a user of the image forming apparatus 101 from the operation unit 205. A Network I/F 206 is connected to a network (not illustrated), such as a local area network (LAN), and inputs/outputs data. An infrared communication module 207 inputs and outputs data to and from the cellular phone 102 through infrared. Each of the above devices is arranged on a system bus 219.

An image Bus I/F 210 is a bus bridge for changing the data structure, and is connected to the system bus 219 and the image bus 220. The image bus 220 is configured with a protocol control information (PCI) bus or Institute of Electrical and Electronic Engineers (IEEE) 1394, and transfers image data at high speeds. On the image bus 220, there are arranged a raster image processor (RIP) 212, a device I/F 213, a scanner image processing unit 214, a printer image processing unit 215, an image rotation unit 216, and an image compression/decompression density conversion unit 211. A RIP 212 develops a PDI code into a bit map image. A device I/F 213 connects a scanner 217, a printer 218, and the controller unit 201. The scanner image processing unit 214 corrects, processes, and edits image data input by the scanner 217. The printer image processing unit 215 performs printing correction and resolution conversion for image data to be output to the printer 218. The image rotation unit 216 rotates image data. The image compression/decompression density conversion unit 211 converts multi-valued image data into a joint photographic experts group (JPEG) format, and performs compressing/decompressing processes, such as joint bi-level image experts group (JBIG), modified modified read (MMR), or modified Huffman (MH), for binary image data.

FIG. 3 is a block diagram illustrating a software function of the image forming apparatus 101 in FIG. 1.

The image forming apparatus 101 is indicated by 301 in FIG. 3. The information forming apparatus 301 includes a scan function unit 302 using the scanner 217. The scan function unit reads paper documents, and converts information into binary or multi-valued image data. The image forming apparatus 301 includes a print function unit 303. The print function unit outputs converted image data which has been read by the Scan function unit 302, to the printer 218. This image data is output together with an added command for the printer 218.

The image forming apparatus 301 includes an infrared communication function unit 304. This infrared communication function unit 304 transmits and receives data to and from the cellular phone 102, using the infrared communication module 207. The image forming apparatus 301 includes a job control function unit 305. The job control function unit 305 performs queuing for image data received from the Scan function unit 302 and image data externally received by the infrared communication function unit 304, as a print job. The job control function unit 305 appropriately outputs the image data to the print function unit 303, the infrared communication function unit 304, or a network function unit 306 as will be described below.

Further, the image forming apparatus 301 includes the network function unit 306. The network function unit has various network protocol functions, such as a transmission control protocol/Internet protocol (TCP/IP), a hypertext transfer protocol (HTTP), a file transfer protocol (FTP), a lightweight directory process protocol (LDAP), a simple network management protocol (SNMP), a simple mail transfer protocol (SMTP), and a secure sockets layer (SSL). Further, the image forming apparatus 301 includes a user interface (UI) function unit (UI) 307. The user interface function unit manages user input/output through the operation unit 205 of the image forming apparatus 301, and displays an input field and an output message field on an operation panel (a display unit of the operation unit 205). Further, the user interface function unit receives an input value from the user for the input field, and transmits the received value to another function unit. The user interface function unit displays a message from another function unit for the user, on the display unit as a screen which has been designed in advance.

Further, the image forming apparatus 301 includes a user authentication function unit 308. The user authentication function unit authenticates the user, who operates various functions of the image forming apparatus, based on user authentication information. This authentication is performed in response to a user authentication request for various applications inside an application function unit 320 as will be described below. This user operation unit is an information processing device (not illustrated) on the UI function unit 307 or a network. The user authentication is realized based on a user authentication server (not illustrated) on a network or user authentication information (not illustrated) inside the image forming apparatus.

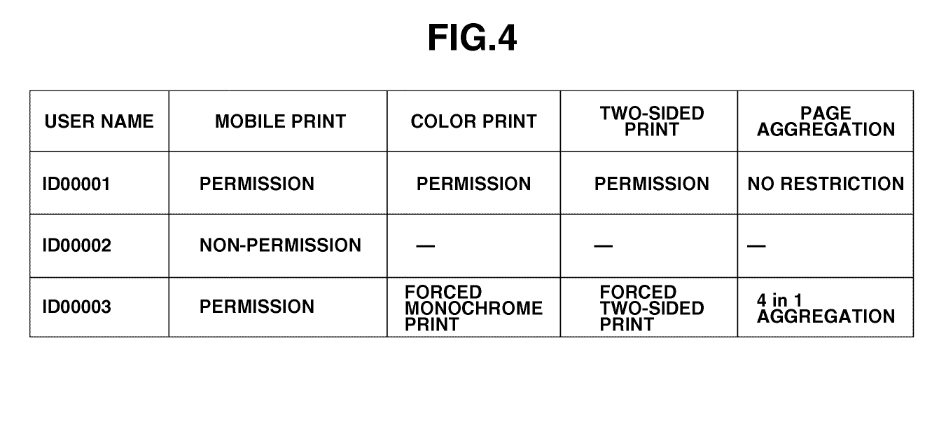

The image forming apparatus 301 is a function restriction control unit 309. A non-volatile storage area, such as the memory 209 of the image forming apparatus 301, stores function restriction information by each user, as illustrated in FIG. 4. The function restriction control unit 309 controls function restrictions that are set according to user, based on the authentication information and function restriction information handled by Login application 322. In an example of the function restriction information of FIG. 4, a user with ID “0001” is permitted to perform mobile printing, color printing, and two-sided printing. In addition, FIG. 4 shows that the user “0001” can use “page aggregation” with no restriction. A user with ID “0002” is prohibited from using the mobile printing. Thus, the user “0002” cannot use color printing, two-sided printing, and page aggregation, in the mobile printing, as well. A user with ID “0003” is permitted to perform mobile printing. In this case, the user is forcibly restricted to use monochrome printing, two-sided printing, and “4 in 1” printing.

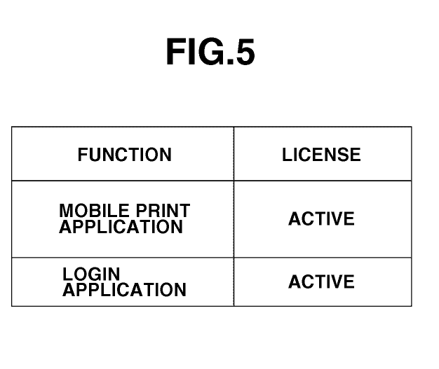

The image forming apparatus 301 includes a license management unit 310. The license management unit 310 manages various applications 321 to 322 operating on the application management unit 320 of the image forming apparatus 301. The license management unit 310 activates the various applications by installing a license key issued by a license information issuing server (not illustrated) therein. In addition, the license management unit 310 uninstalls an already-installed license key with an operation of the UI function unit 307 of the image forming apparatus 301, thereby inactivating them. A non-volatile storage area, such as the memory 209, of the image forming apparatus 301 stores license information for each function illustrated in FIG. 5. The applications become active/inactive, by updating the status of each license in the license information table when the license key is installed/uninstalled. The example of FIG. 5 shows that mobile print application and Login application are presently active in the image forming apparatus 301.

The image forming apparatus 301 includes an application function unit 320. The application function unit 320 authenticates the user, installs, uninstalls, and executes various applications operating on the image forming apparatus 301. The mobile print application 321 is one application of the image forming apparatus 301, operating on the application function unit. The mobile print application 321 communicates with the cellular phone 102 through the infrared communication function unit 304, in response to a communication start instruction from the user, thereby performing a data receiving process. After this, the mobile print application 321 prints received data with the printer 218 according to predetermined print setting, using the print function unit 303, in response to a print setting instruction from the user. The Login application 322 is one application of the image forming apparatus 301, operating on the application function unit. When the user of the image forming apparatus 301 operates the operation unit 205, the Login application 322 executes an authentication process using the user name and password. The Login application 322 realizes authentication in cooperation with the user authentication function unit 308 which keeps actual authentication information. When this authentication process is succeeded, the Login application 322 notifies each application 321 of the application function unit 320 of the authentication information as a Login context. Similarly, the Login application 322 executes a Logout process, when the user of the image forming apparatus 301 ends operating, and starts a Logout operation with the operation unit 205. More specifically, the Login application 322 notifies each application 321 of the application function unit 320 of Logout information for the Login text.

A print process for data stored in the cellular phone 102, executed in the image forming apparatus 101 will now sequentially be described with reference to the flowchart of the image forming apparatus 101.

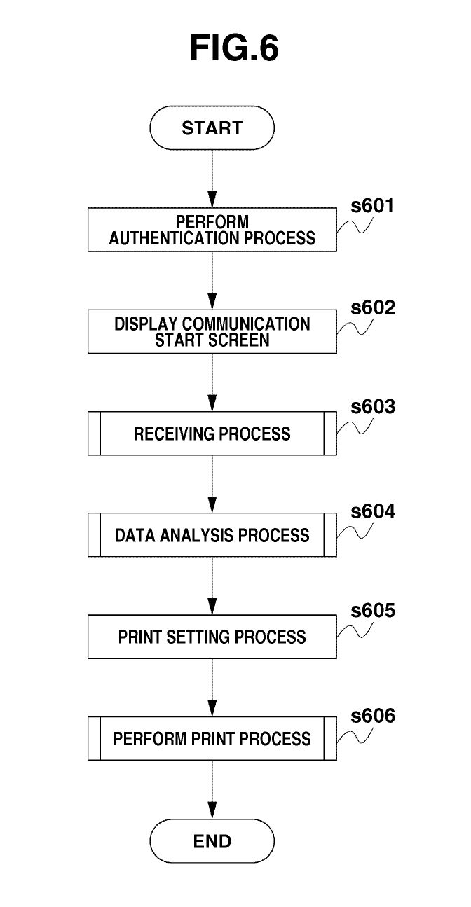

FIG. 6 is a flowchart illustrating the entire flow, since the user logs in to the image forming apparatus 101 until data reception and complete printing. Each step of FIG. 6 is executed by the CPU 202 of the image forming apparatus 101 executing the process based on each software stored in the memory 209.

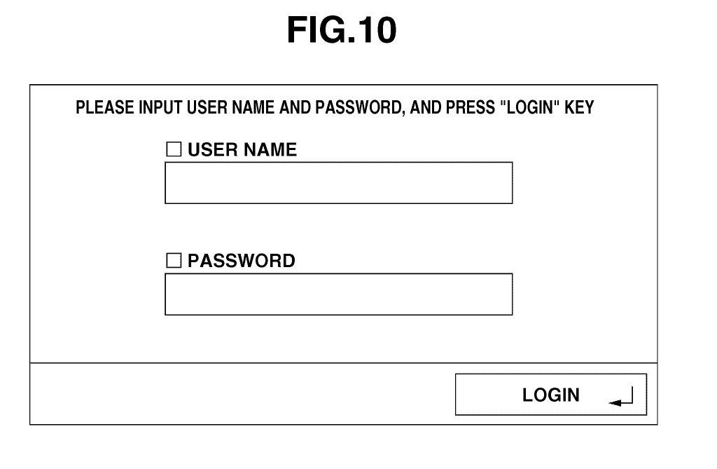

The user operates the operation unit 205 to use the image forming apparatus 101. In this case, the Login application 322 operating on the controller unit 201 displays a screen illustrated in FIG. 10 on the display unit of the operation unit 205, and instructs the user to input authentication information thereon. Then, the user inputs his/her user name and a password to the screen, thereby performing the Login operation. In step S601, the Login application 322 operating on the controller unit 201 executes an authentication process using the input user name and password. When authentication has been succeeded, the Login application 322 notifies each application of the Login context.

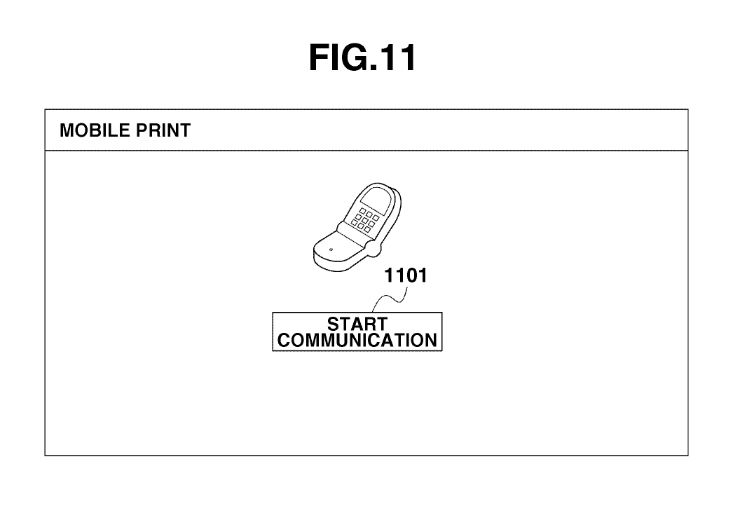

In step S602, when the user Login is performed, and when the user selects execution of the mobile print function, the mobile print application 321 operating on the controller unit 201 controls the display unit of the operation unit 205 to display a communication start screen illustrated in FIG. 11.

The mobile print application 321 operating on the controller unit 201 determines whether a communication start button 1101 has been pressed, as illustrated in FIG. 11. When it is determined that the button has been pressed, the processing proceeds to the following receiving process in step S603.

In S603, the mobile print application 321 operating on the controller unit 201 executes a process for receiving data transmitted from the cellular phone 102. This receiving process will specifically be described below.

When the receiving process in step S603 is completed, in step S604, the mobile print application 321 operating on the controller unit 201 executes a process for analyzing the received data. This data analyzing process will specifically be described below.

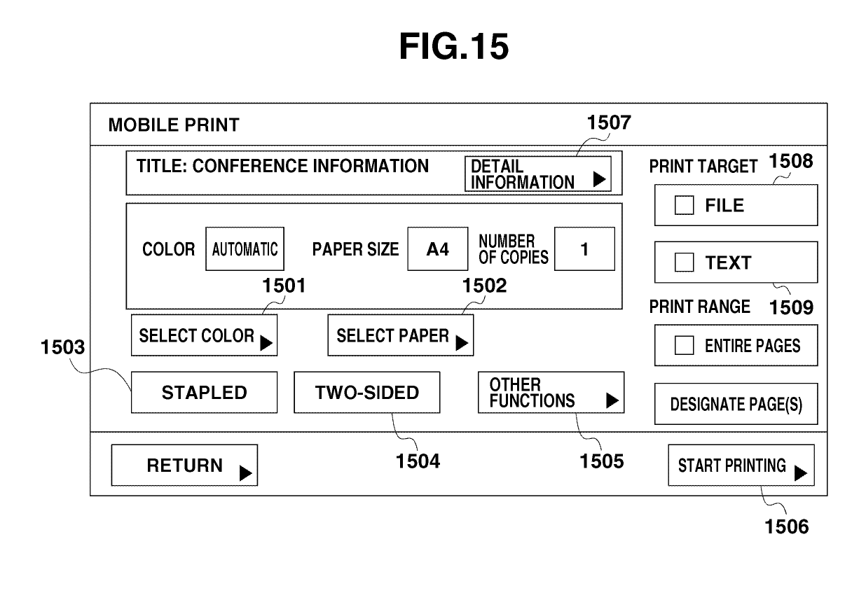

After this, in step S605, the mobile print application 321 operating on the controller unit 201 controls the operation unit 205 to display a print setting screen illustrated in FIG. 15, and performs the print setting process according to user input. FIG. 15 illustrates a setting screen for the user to input a print condition (print setting). In the exemplary embodiment, the mobile print application 321 analyzes the kind of data received by the image forming apparatus 101 from the cellular phone 102 in step S603, and changes the contents of the setting screen displayed according to the analyzed result. More specifically, in step S604, the mobile print application 321 operating on the controller unit 201 creates the setting screen, illustrated in FIG. 15 and displayed on the display unit of the operation unit 205, using the analyzed result of the data analyzing process.

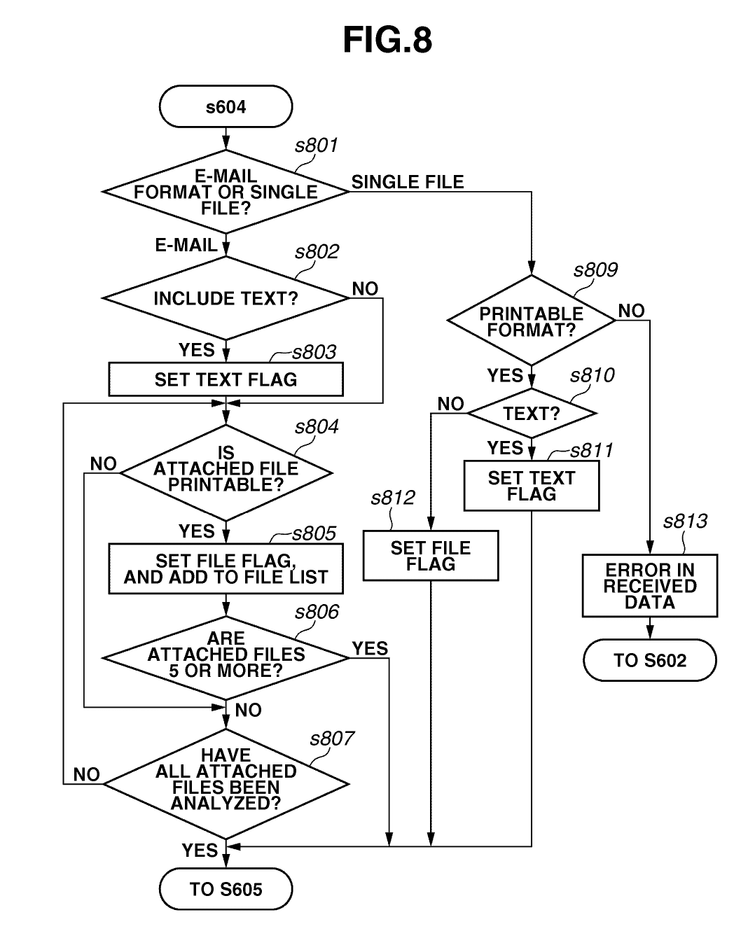

More specifically, upon reception of the analyzed result of the data analyzing process, the mobile print application 321 checks whether a text flag or a file Flag has been set as the analyzed result. FIG. 8 illustrates a process, performed by the mobile print application 321, for setting a text Flag or a file Flag. When a text Flag has been set instead of a file Flag, the application 321 creates a setting screen in which only a text button 1509 is active (can be pressed by the user), of print target buttons 1508 and 1509 on the setting screen in FIG. 15. In this case, the “file” button 1508 is grayed out and thus cannot be selected, or is not displayed. When the file Flag has been set instead of the text Flag, the application 321 creates a setting screen in which only the file button 1508 is active, of the print target buttons 1508 and 1509 on the setting screen of FIG. 15. In this case, the text button 1508 is grayed out and thus cannot be selected, or is not displayed. Further, when both of the text Flag and the file Flag have been set, the application 321 creates a setting screen in which the print target buttons 1508 and 1509 are both active, on the setting screen in FIG. 15.

Further, upon reception of the analyzed result of the data analyzing process, the mobile print application 321 checks whether the analyzed result includes information representing the kind of file. When the analyzed result includes information representing a particular kind of file, the application 321 sets a particular print setting item button to be non-selectable (grayed out or not displayed), of various print setting item buttons. For example, when the analyzed result represents that the kind of file is a Joint Photographic Experts Group (JPEG) file, the application 321 sets a setting item button of “two-sided printing” 1504 to be non-selectable.

The user can select data (text or file) to set the data as target data, from the thus created print setting screen displayed on the display unit. In addition, the user can specify predetermined print setting. For example, the user can specify whether an output should be color-printed or monochrome-printed, using a color-selection button 1501. The user can change the size of printing paper from the standard size (A4) to another size (for example, B5), using a paper selection button 1502. The user can select whether the printed paper should be stapled, using a staple button 1503. Additionally, the user can set the two-sided printing using the “two-sided printing” button 1504. The user can set “2 in 1” or “4 in 1” print setting, using “other functions” button 1505. When the user selects both the text and file as targets to be printed, the print settings can be performed separately between the text and file. For example, the text can be printed in monochrome, while the file can be printed in color. Alternatively, only the common print setting may be set between the text and the file.

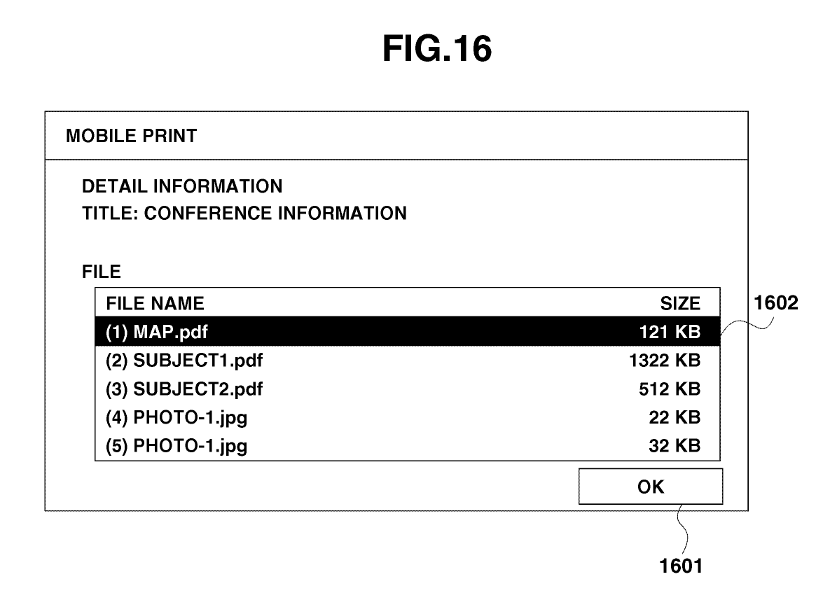

The mobile print application 321 operating on the controller unit 201 displays detail information illustrated in FIG. 16, when a detail information button 1507 of FIG. 15 is pressed. FIG. 16 illustrates an example of a screen displaying a list of files received by the image forming apparatus 101 from the cellular phone 102. In step S604, the mobile print application 321 operating on the controller unit 201 displays the screen of FIG. 16, with the file list included in the analyzed result obtained in the data analyzing process. The mobile print application 321 operating on the controller unit 201 enables the user to select a print target file on this screen. FIG. 16 illustrates that the user has selected the first file (“map.pdf”, 1602). After that, in step S606, if the user presses an “OK” button 1601, the mobile print application 321 operating on the controller unit 201 sets only the file 1602 as a print target file, of files in the file list, in a print process as will be described below.

The mobile print application 321 operating on the controller unit 201 determines whether the user has pressed a “start printing” button 1506 of FIG. 15. In step S606, when it is determined that the user has pressed the button 1506, the processing proceeds to the print process. In step S605, when another operation is done, the print setting process is continued.

In step S606, the mobile print application 321 operating on the controller unit 201 performs a print process according to the print setting process in step S605.

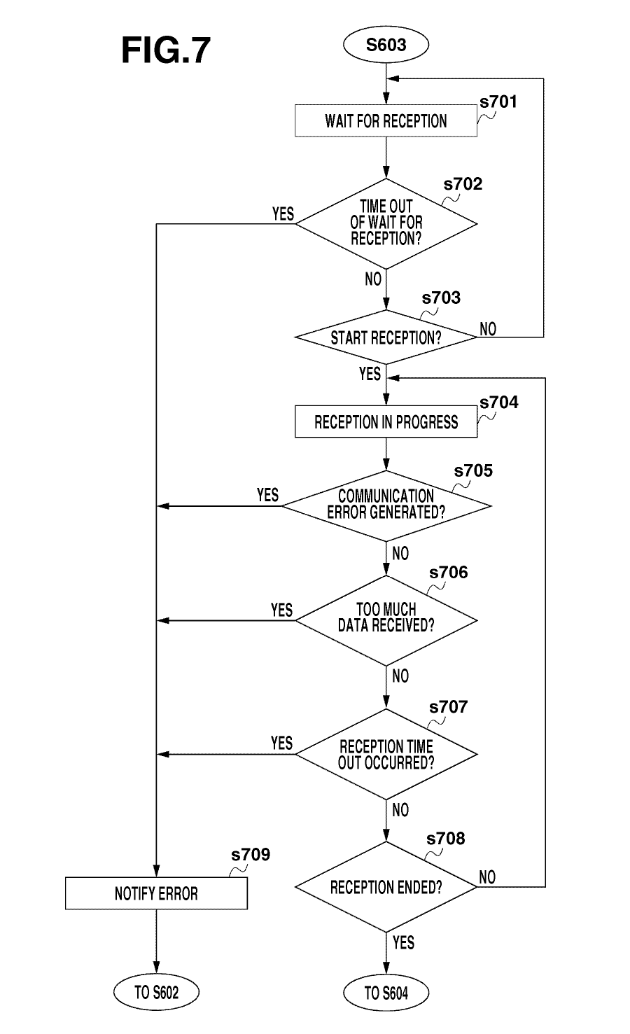

The receiving process in step S603, data analyzing process in step S604 and print process in step S606, illustrated in FIG. 6, will now specifically be described with reference to flowcharts of FIGS. 7, 8 and 9.

FIG. 7 is a flowchart specifically illustrating the receiving process in step S603 of FIG. 6. Each step of the flowchart is executed by the CPU 202 of the image forming apparatus 101 performing the process based on each software stored in the memory 209.

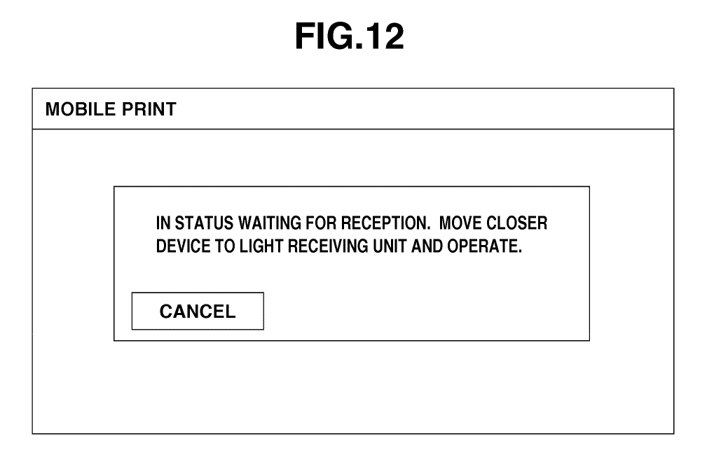

The mobile print application 321 operating on the controller unit 201 controls the display unit of the operation unit 205 to display a screen representing the waiting status, as illustrated in FIG. 12. The mobile print application 321 operating on the controller unit 201 transmits a reception instruction to the infrared communication function unit 304. In step S701, the infrared communication function unit 304 operating on the controller unit 201 sets the infrared communication module 207 on the controller unit 201 into an infrared reception waiting status, in response to the transmitted instruction.

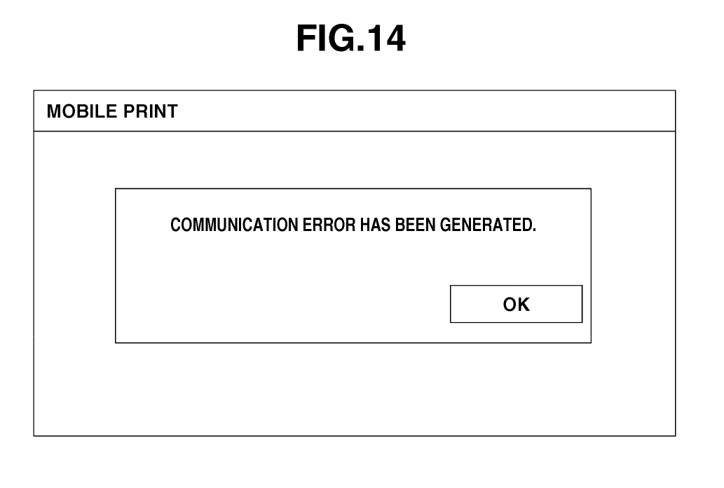

In step S702, the mobile print application 321 operating on the controller unit 201 determines whether the waiting time for receiving a signal from the cellular phone 102 has elapsed a predetermined period of time. In step S709, when the predetermined period of time has elapsed, the application 321 controls the display unit to change the message and display the changed message “communication time out”, as illustrated in FIG. 14.

In step S709, the mobile print application 321 operating on the controller unit 201 determines whether data reception from the cellular phone 102 has begun. In step S704, when data reception has begun, the processing proceeds to the following “during reception” step. When data reception has not begun yet, the processing repeats step S701.

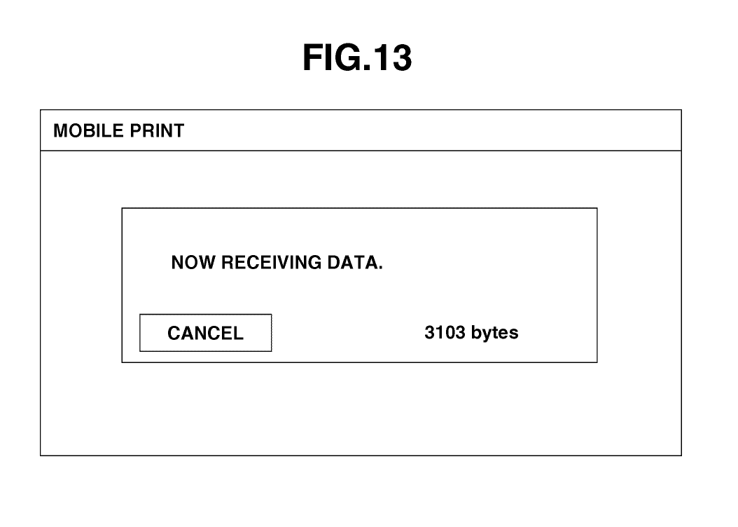

When it is determined that the data reception has begun, the mobile print application 321 operating on the controller unit 201 controls the display unit to display a “receiving screen” illustrated in FIG. 13. In step S704, the infrared communication function unit 304 operating on the controller unit 201 receives data from the cellular phone 102 through the infrared communication module 207, and transmits the received data to the mobile print application 321.

In step S705, the mobile print application 321 operating on the controller unit 201 determines whether some kind of reception error has been generated. In step S709, when a reception error has been generated, the application 321 controls the display unit to display information about a communication error as illustrated in FIG. 14, and notifies the user of the error. The application 321 notifies the infrared communication function unit 304 of the reception error. The infrared communication function unit 304 cancels the communication with the cellular phone 102 through the infrared communication module 207. When no reception error has been generated, the processing proceeds to step S706.

In step S706, the mobile print application 321 operating on the controller unit 201 determines whether data with a larger data size than a predetermined reception buffer size is being received. In step S709, when the data with the large data size is being received, the application 321 controls the display unit to change the message and display the changed message “Exceeded maximum receivable data size”, as illustrated in FIG. 14, and notifies the user of this. The application 321 notifies the infrared communication function unit 304 of the reception error. The infrared communication function unit 304 cancels communication with the cellular phone 102 through the infrared communication module 207. When the data size of the data being received is not larger than the reception buffer size, the processing proceeds to step S707.

In step S707, the mobile print application 321 operating on the controller unit 201 determines whether a predetermined period of time has elapsed for receiving the data (whether time out of the receiving data has occurred). In step S709, when it is determined that time out of the receiving data has occurred, the application 321 controls the display unit to change the message of FIG. 14 and display the changed message “communication time out has occurred”, and notifies the user of it. The application 321 notifies the infrared communication function unit 304 of the reception error. The infrared communication function unit 304 cancels communication with the cellular phone 102 through the infrared communication module 207. When no reception time out has occurred, the processing proceeds to step S708.

In step S708, the mobile print application 321 operating on the controller unit 201 determines whether data transmission from the cellular phone 102 is completed. In step S604, when the transmission is completed, the processing proceeds to a data analyzing process. When the data is still being received, the processing returns to step S704, and continues the receiving process.

FIG. 8 is a flowchart specifically illustrating the data analyzing process in step S604 of FIG. 6. Each step of the flowchart is executed by the CPU 202 of the image forming apparatus 101 performing the process, based on each software stored in the memory 209.

In step S801, the mobile print application 321 operating on the controller unit 201 determines whether the data received in the receiving process in step S603 is data in an e-mail format or data in a single file format. More specifically, when the received data is in a Multipurpose Internet Mail Extension (MIME) format, the application 321 determines that the received data is in an e-mail format. When the data is in any other data format (file in a portable document format (PDF) format or JPEG format), the application 321 determines that the data is in a single file format. In step S802, when the received data is in an e-mail format, the processing proceeds to an e-mail analyzing routine. In step S809, when the received data is in a single file format, the processing proceeds to a single file format processing routine.

In step S802, when the received data is in an e-mail format, the mobile print application 321 operating on the controller unit 201 determines whether the e-mail includes text data. More specifically, the application 321 interprets the received MIME data. When header information representing the e-mail text is included, the application 321 determines that there is text data in the e-mail. In step S803, when it is determined that there is the text, the mobile print application 321 operating on the controller unit 201 sets a text Flag to information representing the analyzed result. In step S804, the processing proceeds to an attached file analyzing routine. In step S804, when there is no text in the e-mail, the processing proceeds to the attached file analyzing routine without setting the text Flag.

The mobile print application 321 operating on the controller unit 201 interprets the MIME data, and determines whether header information representing an attached file is included therein. When it is determined that the attached file is included in the data, the application 321 successively analyzes the attached file(s) included in the e-mail. In step S804, the application 321 determines whether the attached file is in a printable PDF format or a JPEG format, or in a non-printable JIF format.

In step S805, when the attached file is included in the e-mail data, and when the file is in a format that is printable by the image forming apparatus 101, the application 321 sets a file Flag to information representing the analyzed result, and adds the file name of the attached file into the file list. As a result, the file can be selected as a target to be printed. The application 321 adds information representing the format (kind) of the file, into information representing the analyzed result. Then, the processing proceeds to a process for determining the number of attached files in step S806. On the contrary, when the attached file is in a format that is not printable by the apparatus 101, the processing proceeds to step S807. Since any attached file that is not printable by the apparatus is not included in the file list, it is possible to extract only printable files and create a file list for such files, even when many non-printable files are attached to the data.

After this, in step S806, the mobile print application 321 operating on the controller unit 201 checks the number of attached files registered in the file list. In step S605, when the number of attached files is equal to or greater than a predetermined number (the number is 5 or more, in the present exemplary embodiment), the application 321 ends the process for the attached files, and the processing proceeds to a print setting process. When the number of attached files is equal to or smaller than a predetermined number, the processing proceeds to step S807. Accordingly, by setting the maximum number of attached files to be processed, it is possible to avoid taking too much time in the processing, and to reduce the processing load on the image forming apparatus 101, when e-mail data with a great number of attached files is received.

In step S807, the mobile print application 321 operating on the controller unit 201 determines whether all the attached files have been analyzed. In step S605, when all the attached files have been analyzed, the process for the attached files ends, and the processing proceeds to the print setting process. When there is some attached file that has not been processed yet, the processing returns to step S804 to execute the process for the following attached file.

As a result of the determination in step S801, in step S809, when the received data is in a single file format (file data), the mobile print application 321 determines whether the file is in a format printable by the image forming apparatus 101. When the file is a printable format, the processing proceeds to step S810. In step S813, when the file is non-printable format, the application 321 controls the display unit of the operation unit 205 to change the message and display the changed message “non-supported data format”, which is notified to the user.

In step S810, when it is determined that the file is in a printable format in step S809, the mobile print application 321 operating on the controller unit 201 determines whether the file is text data. In step S811, when the file is text data, the application 321 sets a text Flag to information representing the analyzed result. In another case, the application 321 sets a file Flag to information representing the analyzed result, and adds the file name of the corresponding file into the file list. Further, the application 321 adds information representing the format (kind) of the file to the information representing the analyzed result. In step S605, the mobile print application 321 operating on the controller unit 201 ends the data analyzing process, and the processing proceeds to the print setting process.

After this, the information, representing the analyzed result generated through the flow of FIG. 8, is referred by the mobile print application 321, and is used for creating a setting screen suitable for each situation. As a result, the print setting screen illustrated in FIG. 15 is displayed.

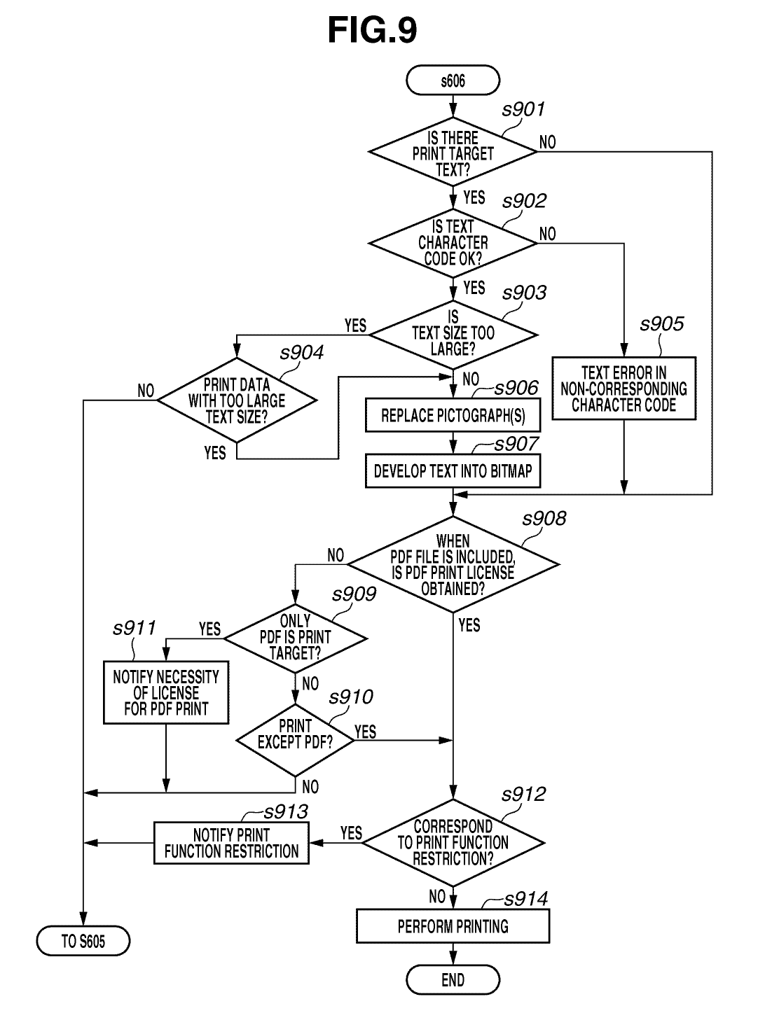

FIG. 9 is a flowchart specifically illustrating the print process in step S606 of FIG. 6. Each step of the process can be executed by the CPU 209 of the image forming apparatus 101 performing the process based on each software stored in the memory 209.

In step S901, the mobile print application 321 operating on the controller unit 201 determines whether there is text as a print target. When it is determined that there is text as the print target, the processing proceeds to step S902. When it is determined that there is no text, the processing proceeds to step S908. On the print setting screen illustrated in FIG. 15, the application 321 determines whether the user specifies the text button 1509 for print target data.

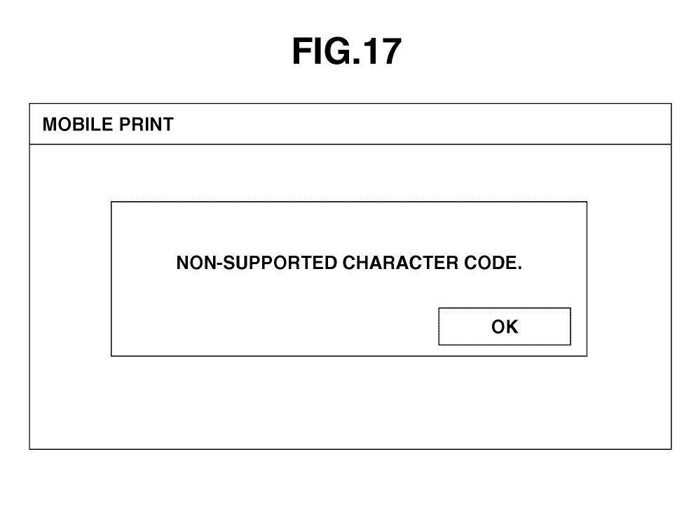

In step S902, the mobile print application 321 operating on the controller unit 201 checks the character code of the text, when there is text as the print target. When the character code of the text is a corresponding character code (character code interpretable by the image forming apparatus 101), the processing proceeds to step S903. In step S905, when the character code is a non-corresponding character code (non-interpretable by the image forming apparatus 101), the application 321 controls the display unit of the operation unit 205 to display the screen illustrated in FIG. 17, and notifies the user of this. In step S908, the processing proceeds to the process of the attached file.

In step S903, the mobile print application 321 operating on the controller unit 201 checks the size of the e-mail text included in the data received from the cellular phone 102. In step S906, when the size is not too large, the processing proceeds to a process for replacing the following pictograph. When the size is too large, the processing proceeds to step S904.

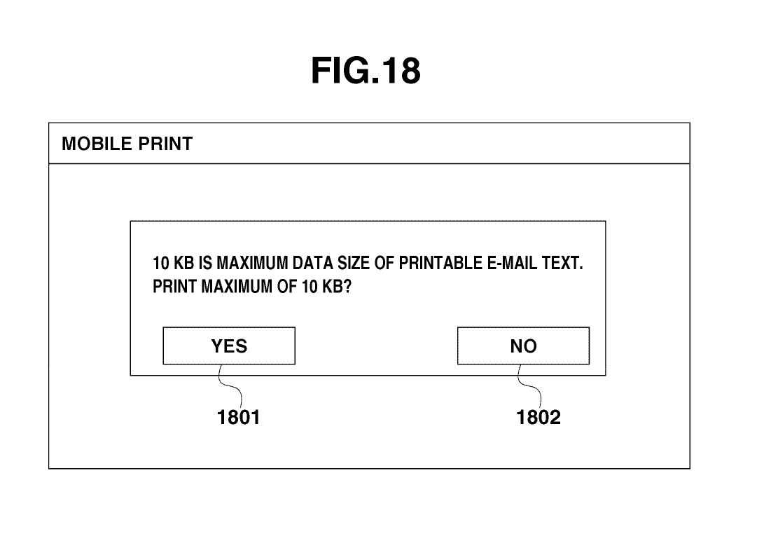

In step S903, when the character code is a corresponding character code, the mobile print application 321 determines whether the text size of the received text data is too large. When the text size of the received text data is too large, the application 321 controls the display unit of the operation unit 205 to display the screen illustrated in FIG. 18, and notifies the user of it. In step S904, the mobile print application 321 operating on the controller unit 201 determines whether to execute the printing. More specifically, when the user presses “YES” 1801 as an instruction for printing, as illustrated in FIG. 18, the application 321 determines to execute the printing, and the processing proceeds to step S906. In step S605, when the user presses “NO” as an instruction for not printing, as illustrated in FIG. 18, the application 321 determines not to execute the printing, and the processing returns to the print setting process. As a result, it is possible to print and output the data up to a data size equal to or smaller than a predetermined size, even when the data size of the text data is equal to or larger than the predetermined size (for example, 10 KB).

In step S906, the mobile print application 321 operating on the controller unit 201 executes a process for replacing some character code in the text with a particular character (for example, “▪”). An example of this character code in the text is a pictograph(s) peculiar to the cellular phones. In step S907, the application 321 executes a process for developing the data into bitmap data, as a format for printing the text. As a result, the user can easily know that the text has included some pictograph, because the text including the character code (for example, a pictograph) peculiar to the cellular phone is replaced with a particular character, when the text data is printed out.

In step S908, the mobile print application 321 operating on the controller unit 201 checks a PDF license in the license management unit 310, when a PDF file is included as a target to be printed. The PDF license indicates information representing that the image forming apparatus 101 is permitted to print the PDF file. In step S912, when there is the license, the processing proceeds to a process for checking the following print function restriction. When there is no such a license, the processing proceeds to step S909.

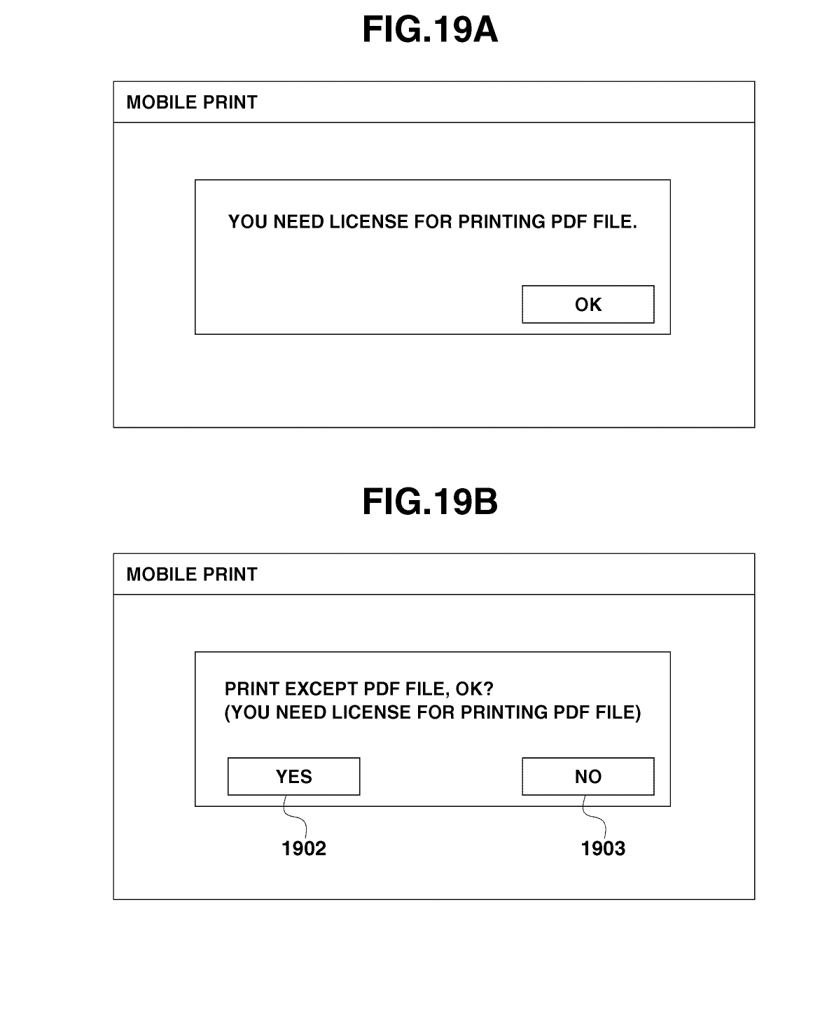

In step S909, the mobile print application 321 operating on the controller unit 201 checks whether the PDF file is only the target to be printed, when there is no PDF license. When there is only the PDF file, it is not possible to print the file. Thus, in step S911, the mobile print application 321 operating on the controller unit 201 controls the display unit of the operation unit 205 to display the screen illustrated in FIG. 19A, and notifies the user of this. In step S910, when there is data other than the PDF file, the mobile print application 321 controls the display unit of the operation unit 205 to display the screen illustrated in FIG. 19B, and checks whether the user gives an instruction to print only data other than the PDF file. In step S912, when the user presses “YES” 1902 as an instruction for printing, as illustrated in FIG. 19B, the mobile print application 321 operating on the controller unit 201 proceeds to the process for checking the following print function restriction, as to the target data to be printed other than the PDF file. In step S605, when the user presses “NO” 1903 as an instruction for printing, as illustrated in FIG. 19B, the processing proceeds to the print setting process.

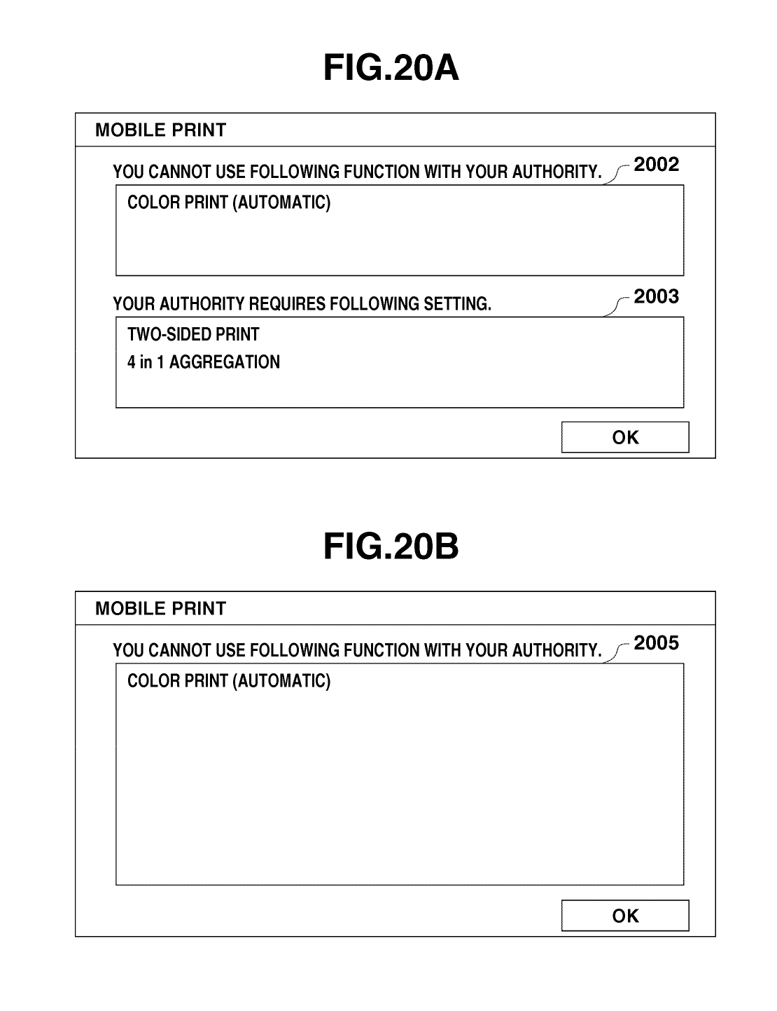

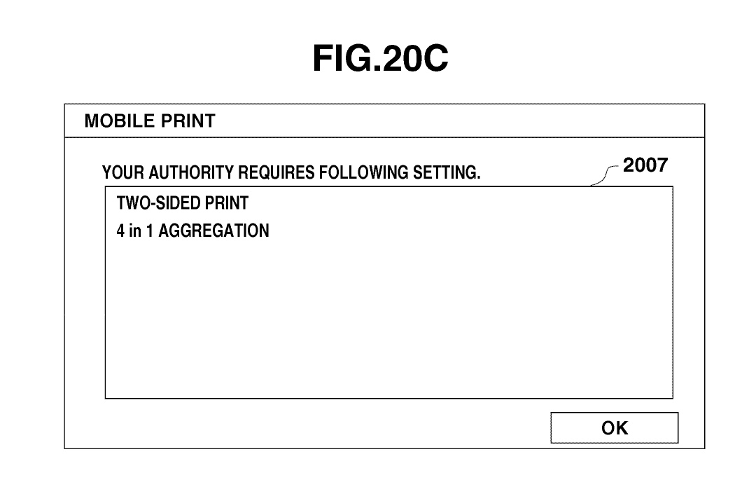

The mobile print application 321 inquires of the function control unit 30 about whether the print setting set in the print setting process in step S605 can be realized with the authority of the user who has currently logged into the image forming apparatus 101. In step S912, the application 321 determines whether the print setting corresponds to the function restriction. In step S914, when the print setting does not correspond to the function restriction, the mobile print application 321 operating on the controller unit 201 prints target data to be printed (text data or image data). In step S913, when the print setting corresponds to the function restriction, the application 321 controls the operation unit 205 to display the non-usable function (2002) or the setting (2003), as illustrated in FIG. 20. Then, the processing returns to the print setting process in step S605. The mobile print application 321 operating on the controller unit 201 changes the display according to the restriction condition, when notifying the function restriction. When the non-usable function (2002) and the setting (2003) are found, the application 321 performs control to display the screen illustrated in FIG. 20A. When only the non-usable function (2005) is found, the application 321 performs control to display the screen illustrated in FIG. 20B. When only the function (2007) is found, the application 321 performs control to display the screen illustrated in FIG. 20C.

By performing the above processes, the image forming apparatus 101 can receive and print the data transmitted from the cellular phone 102. At this time, the image forming apparatus 101 creates and displays the screen suitable for the user operations, according to the kind of data received from the cellular phone 102. This can improve the user operability.

In the above exemplary embodiment, the descriptions have been made about the example, in which the image forming apparatus 101 performs the process for printing (mobile printing) the data received from the cellular phone 102. However, the image forming apparatus 101 may execute any image forming process, other than the print process. For example, the image forming apparatus may execute a process for transmitting the data received from the cellular phone 102 to another device through network. In this case, this data transmission is done using a communication protocol, such as a Simple Mail Transfer Protocol (SMTP), a simulated moving bed (SMB), and a file transfer protocol (FTP). The image forming apparatus 101 may perform a process for sending the received data through a fax.

### Other Embodiments

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-148011 filed Jun. 22, 2009, which is hereby incorporated by reference herein in its entirety.

What is claimed is:

1. An image forming apparatus communicable with an information apparatus through wireless communication, comprising:
a determination unit configured to determine whether data received from the information apparatus is in an e-mail format; and
a display unit configured, in response to reception of the data, to display a letting screen to let a user select forming an image of e-mail text included in the data or forming an image of an attached file included in the data, when the data is in an e-mail format, and to display a setting screen for setting an image forming condition, when the data is not in an e-mail format.

2. The image forming apparatus according to claim 1, wherein
the display unit displays different setting screens according to a kind of the received data, when the data is not in an e-mail format.

3. The image forming apparatus according to claim 1, wherein
when the data is not in an e-mail format, the display unit sets a button as non-selectable on the setting screen, which corresponds to a particular image forming condition, if the data is a particular kind of data.

4. The image forming apparatus according to claim 1, further comprising:
an authorization unit configured to perform an authorization process for the user;
a second determination unit configured to determine whether the authorized user can use a function, using restriction information indicating a function which use is restricted for each user, among functions in the image forming apparatus; and
a restriction unit configured to restrict use of a function that the user cannot use based on a determination result.

5. The image forming apparatus according to claim 1, wherein
the letting screen is a screen displaying a button for selecting forming the image of e-mail text or forming the image of the attached file, on a setting screen for setting an image forming condition.

6. The image forming apparatus according to claim 1, wherein
the display unit displays the setting screen that restricts selection of file data to be formed as an image, when the data determined as data not in an e-mail format is text data, and
the display unit displays the setting screen that restricts selection of text data to be formed as an image, when the data determined as data not in an e-mail format is not text data.

7. The image forming apparatus according to claim 1, further comprising an image forming unit configured to form an image of the received data, according to the image forming condition.

8. The image forming apparatus according to claim 1, wherein
the wireless communication is infrared communication, and
the image forming apparatus starts infrared communication with the information apparatus, in response to a user instruction that is input for starting communication to the image forming apparatus.

9. A method for controlling an image forming apparatus communicable with an information apparatus through wireless communication, the method comprising:
determining whether data received from the information apparatus is in an e-mail format; and
displaying a letting screen, in response to reception of the data, to let a user select forming an image of e-mail text included in the data or forming an image of an attached file included in the data, when the data is in an e-mail format, and displaying a setting screen for setting an image forming condition, when the data is not in an e-mail format.

10. The method according to claim 9, further comprising, when the data is not in an e-mail format, setting a button as non-selectable on the setting screen, which corresponds to a particular image forming condition, if the data is a particular kind of data.

11. The method according to claim 9, further comprising:
performing an authorization process for the user;
determining whether the authorized user can use a function, using restriction information indicating a function which use is restricted for each user, among functions in the image forming apparatus; and
restricting use of a function that the user cannot use based on a determination result.

12. The method according to claim 9, wherein
the letting screen is a screen displaying a button for selecting forming the image of e-mail text or forming the image of the attached file, on a setting screen for setting an image forming condition.

13. The method according to claim 9, wherein
the displaying displays the setting screen that restricts selection of file data to be formed as an image, when the data determined as data not in an e-mail format is text data, and
the displaying displays the setting screen that restricts selection of text data to be formed as an image, when the data determined as data not in an e-mail format is not text data.

14. The method according to claim 9, wherein
the wireless communication is infrared communication, and
the image forming apparatus starts infrared communication with the information apparatus, in response to a user instruction that is input for starting communication to the image forming apparatus.

15. A recording medium storing a program for controlling an image forming apparatus, communicable with an information apparatus through wireless communication, to execute operations comprising:
determining whether data received from the information apparatus is in an e-mail format; and
displaying a letting screen, in response to reception of the data, to let a user select forming an image of e-mail text included in the data or forming an image of an attached file included in the data, when the data is in an e-mail format, and displaying a setting screen for setting an image forming condition, when the data is not in an e-mail format.

16. The recording medium according to claim 15, further comprising, when the data is not in an e-mail format, setting a button as non-selectable on the setting screen, which corresponds to a particular image forming condition, if the data is a particular kind of data.

17. The recording medium according to claim 15, further comprising:
performing an authorization process for the user;
determining whether the authorized user can use a function, using restriction information indicating a function which use is restricted for each user, among functions in the image forming apparatus; and
restricting use of a function that the user cannot use based on a determination result.

18. The recording medium according to claim 15, wherein
the letting screen is a screen displaying a button for selecting forming the image of e-mail text or forming the image of the attached file, on a setting screen for setting an image forming condition.

19. The recording medium according to claim 15, wherein
the displaying displays the setting screen that restricts selection of file data to be formed as an image, when the data determined as data not in an e-mail format is text data, and
the displaying displays the setting screen that restricts selection of text data to be formed as an image, when the data determined as data not in an e-mail format is not text data.

20. The recording medium according to claim 15, wherein
the wireless communication is infrared communication, and
the image forming apparatus starts infrared communication with the information apparatus, in response to a user instruction that is input for starting communication to the image forming apparatus.
